(19) United States
(12) Patent Application Publication
(10) Pub. No.: US 2008/0320009 A1
(43) Pub. Date: Dec. 25, 2008

(54) SYSTEMS AND METHODS FOR ASSET MAPPING

(76) Inventors: Willem Scholten, Seattle, WA (US); Andrew C. Gordon, Seattle, WA (US)

Correspondence Address: BLACK LOWE & GRAHAM, PLLC, 701 FIFTH AVENUE, SUITE 4800, SEATTLE, WA, 98104, US

(21) Appl. No.: 11/747,858

(22) Filed: May 11, 2007

Related U.S. Application Data
(60) Provisional application No. 60/747,077, filed on May 11, 2006.

(51) Int. Cl. G06F 7/00; G06F 17/00

(52) U.S. Cl. 707/100; 707/E17.033

(57) ABSTRACT

Systems and methods for asset mapping include storing at least one asset instance on a computer readable medium. The asset instance is processed such that the processed extracted data is stored within a series of field in at least one data store. The asset is mapped using a predefined asset linking process. The map of asset links is displayed to a user on a user interface.

### PRIORITY CLAIM

This application is related to U.S. Provisional Application No. 60/747,077 filed on May 11, 2006 and is hereby incorporated by reference in its entirety herein.

### BACKGROUND OF THE INVENTION

There currently exists a longstanding problem related to the interaction with and the display of “community assets.” The current system and method of evaluating the assets of a community is outdated. It fails to address community building efforts, social service delivery data, grant making targeting, business performance, and historical events such as genealogy.

Currently there is a need for: a dynamic system that enables the display of “assets” and their relationships in “real time” using various novel graphical (computer driven) interactive display methodologies; a dynamic system that allows for ongoing real-time interaction with the assets and the “shifting” of the focus (view) and vantage points from which the asset relationships are viewed and analyzed; and a dynamic system that allows for the exploration and mapping of forecasted asset relationships 1, 2, 3, or n steps removed including potential non-obvious relationships between asset instances where there is no direct asset link.

### SUMMARY OF THE INVENTION

A preferred embodiment of the present invention includes, but is not limited to the following components: (a) a software-encoded process to record asset relationships for machine-based analysis to facilitate the exploration and visualization of potential new “unexpected” and “unpredictable” asset relationships; (b) a software-encoded process to store and facilitate asset analysis, deploying a data object storage method that allows variable fields with variable subfields and data length, and data element links both within records and between records, incorporating many-to-many relationships at each level. This data storage and retrieval system has wide applicability beyond the use within this invention. (For example, for the dynamic encoding of family histories, or genealogy); (c) a software encoded process that allows for the dynamic exploration and mapping of forecasted relationships 1, 2, 3, n steps removed and subsequent visualization of these existing and potential asset relationships in multiple coordinate systems; and/or (d) a software-encoded process to visualize potential relationships based on commonalities and/or differences within the encoded asset instances.

In one embodiment, the system and method is encoded and implemented to provide for a dynamic online system for analysis of “asset” relationships. The tool set has broad application—including community building efforts; social service delivery data; grant making targeting; business process engineering and the analysis of business performance; the encoding of historical events (patterns) such as genealogy. Because of its procedures for displaying and analyzing existing asset relationships between objects and the ability to predict potential new asset relationships, this invention has wide applicability for any situation where relationship analysis is relevant.

An “asset based” perspective involves documenting the tangible and intangible resources of a community, and emphasizes viewing a community as a place with assets to be preserved and enhanced, rather than dwelling on deficits to be remedied.

The term, “asset mapping,” is used herein to broadly capture the mapping of interactions (adhesion) of any type of assets—where community refers to entities, which share a physical or conceptual space. Characterizations of communities include the interactions that take place at many different levels and in many different ways. As referred to herein the term “community” is multifaceted; the term is used, for example, to describe geographic communities (e.g., neighborhoods) and social communities (that is, not only all the residents of a bounded urban area, but also a business community where store owners, wherever located, interact, or where single businesses interact with their partners, suppliers, customers). Thus, “asset mapping” refers generally to the process of documenting the tangible and intangible resources being shared and acted upon at the many levels of interaction. Any of these interactions can be captured, preserved, described, and potentially enhanced.

As illustrated more particularly with reference to the accompanying figures and attendant textual descriptions, the linked and displayed assets, which include, but are not limited to people, organizations, communities, companies, and business processes, are analyzed based on individual or shared and commonly held asset relations. To facilitate the development of enhanced relationships for community (business, product, and process) enrichment, the system and method captures displays and analyzes not only the existence and types of interactions, but also the strength of their relationships.

In one embodiment, the system and method includes, but is not limited to the following components: (a) data is visualized and presented for analysis and explored within a boundless set of asset relationships. A predetermined starting point—the initially known asset relationship—can be further explored using a dynamically generated set of expected and unexpected relationships in n dimensions; (b) data is visualized and presented for analysis and explored within a boundless set of grouped “asset instances,” either having certain common or differentiating characteristics; (c) the visualization of asset relationships can be within multiple coordinate systems—including various traditional GIS based coordinates (longitude/latitude) but also X-Y-Z coordinate systems of known and potential asset relationships; (d) the system provides the capacity dynamically to change the focal point in which data are viewed within the various coordinate systems, and allows for the further exploration of known and potential asset relationships within this new n-dimensional focal plane; (e) the system provides a flexible method to encode asset relationships without requiring their predetermination. (i.e. the way the asset link is encoded does not require that additional (even potential) asset relationships—i.e. those 1+n steps removed from the original) be predetermined; (f) the system provides a flexible method to group “asset instances” into sets based on commonalities and/or differences.) These sets may be further analyzed and filtered into any number of new sets, including those with established asset links (relationships), and those with links that have yet to be revealed. Revealed sets may unearth new relationships worth exploration; (g) the data model allows for an unlimited number of relations between data objects (records) and for records to contain a variable number of fields. Fields may also contain variable numbers of subfields, and the system incorporates the ability to have repeatable fields within the same data object (record) as well as have subfields repeated within the same field. Further, fields within a record may have multiple relationships to other fields within the same data record (object), enabling flexibility in data collection, storage, and display with wide potential applicability. This data model is innovative in and of itself, with vast potential for recording data beyond the core use within this invention.

In one embodiment, the system and method consists of a number of processes that facilitate the collection, display, and analysis of asset relationships, preferably using computer based online tools and software-encoded processes. Users of the present invention provide data for analysis, visualization and exploration, preferably through either a basic data-encoding interface within a coordinate system (GIS—longitude/latitude based or other two or three dimensional coordinate spaces) or through uploading and importing existing data in common data formats. (i.e. CSV, XML, excel, dbf, SQL).

Data to be “asset mapped” can be of multiple and varied main types (examples include people, places, organizations, business partners, clients, suppliers, etc), which can be specified by the user. Within each of these main types, relationships—or “asset links”—can be encoded to capture various types of relationships among entities.

Asset links (relationships) are broadly categorized using 6 unique types of relationship attributes: resource_of, resource_to, contained_by, contained_within, see_also, and see_instead. Asset relationships (asset links) are designed within the system to incorporate various data types, including “normalized” labels, free form descriptions, time limits and self- or machine-assigned “weights” indicating the ‘strength’ of the encoded asset link (relationship). Data objects may have “many to many” asset relationships, in essence forming an n-dimensional hypercube of object links.

Asset links (relationships) in the 1^{st} dimension, created through a data-import or data-entry method, enable the inclusion of links among objects, incorporating the (optional) perceived strength (weight) of the asset relationship. Asset links in the 2^{nd} and higher dimensions are machine generated, using a process that analyzes the type of asset links and the connected shortest path to other assets, which can be reached from the user's “focal point.” That focal point itself can be modified dynamically by the user.

By visually displaying the direct and associated (calculated) asset relationships, and allowing for the dynamic changing of the “focal point,” the present invention provides data in a way that allows understanding of unexpected asset based links warranting further exploration. These links may themselves be candidates for establishing potential new associations (collaborations, business relationships). Asset instances can also be explored using sets, which can be dynamically generated based on commonalities and/or differences. This dynamic system, which can incorporate multiple coordinate systems, allows users to see the information in a wide variety of mathematical displays, well beyond such familiar displays as traditional street maps.

An asset mapping system, in one embodiment, consists of, but is not limited to the following sections: a generalized implementation model; a generalized data storage model, detailed asset instances recording a model and a process; a plurality of generalized data store access methods, an asset link definition and recording model, and an asset exploration and analysis model.

### BRIEF DESCRIPTION OF THE DRAWINGS

The preferred and alternative embodiments of the present invention are described in detail below with reference to the following drawings.

FIG. 1 shows a generalized implementation model;

FIG. 2 shows a data storage model in one embodiment;

FIG. 3 shows a data storage model representing asset instance relationships;

FIG. 4 shows an asset instance store;

FIG. 5 shows an example asset instance main data structure;

FIG. 6 shows an example of links of fields and subfields within a single asset instance;

FIG. 7 shows an example of asset relationship exploration;

FIG. 8 shows automatic creation of asset instances using imported data;

FIG. 9 shows an example of interactive creation of asset instances;

FIG. 10 shows an example of a manual, non coordinate system based asset instance recording;

FIG. 11 shows an example of pre-defined asset link creation based on pre-coded relationships;

FIG. 12 shows an example of asset link creation based on imported data;

FIG. 13 shows an example of manual asset link creation;

FIG. 14 shows an example of machine asset link creation;

FIG. 15 shows an example of potential asset link discovery one plus n steps removed from a known relationship; and

FIG. 16 shows an example of an asset relationship exploration process.

### DETAILED DESCRIPTION OF THE PREFERRED EMBODIMENT

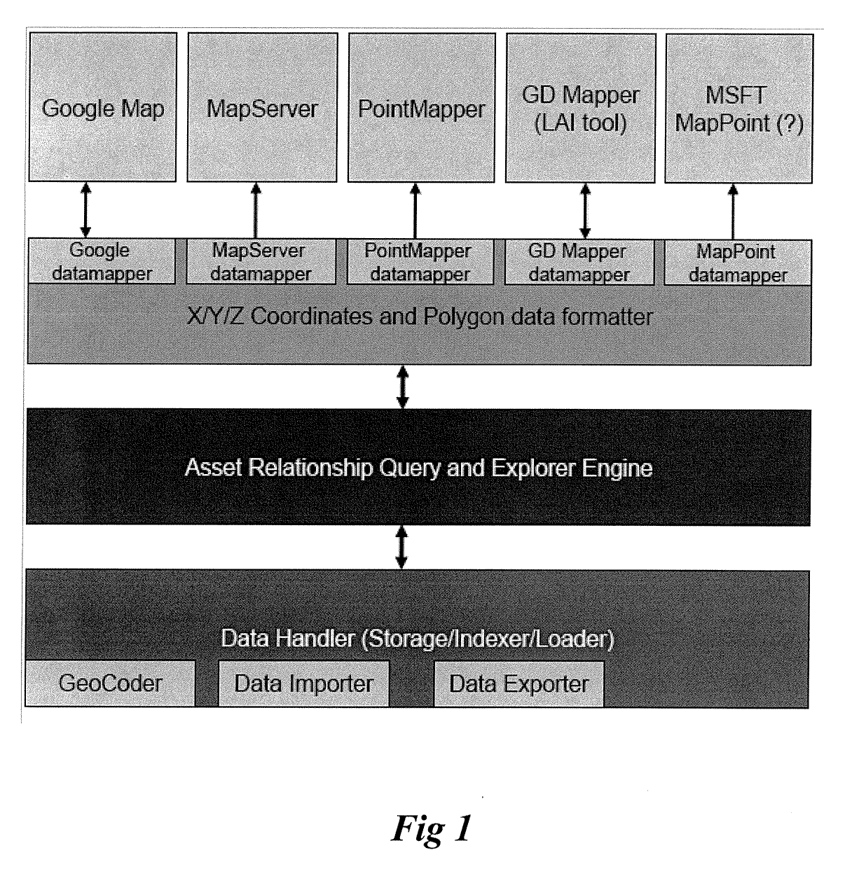

FIG. 1 shows a generalized implementation model. Information is gathered from a web service and is processed in both a data formatter and an asset relationship query and explorer engine. In these areas, relationships are explored, related, linked, and weighted on overall strength and weakness. In a data handler layer of the implementation model, data (an asset instance) is validated and normalized against a varying and appropriate set of control tables. Asset instances are GeoCoded if applicable, and/or assigned appropriate coordinates within a polygon system. Further asset instances may be connected to other relevant datasets through a machine-based process, automatically enriching the asset instance.

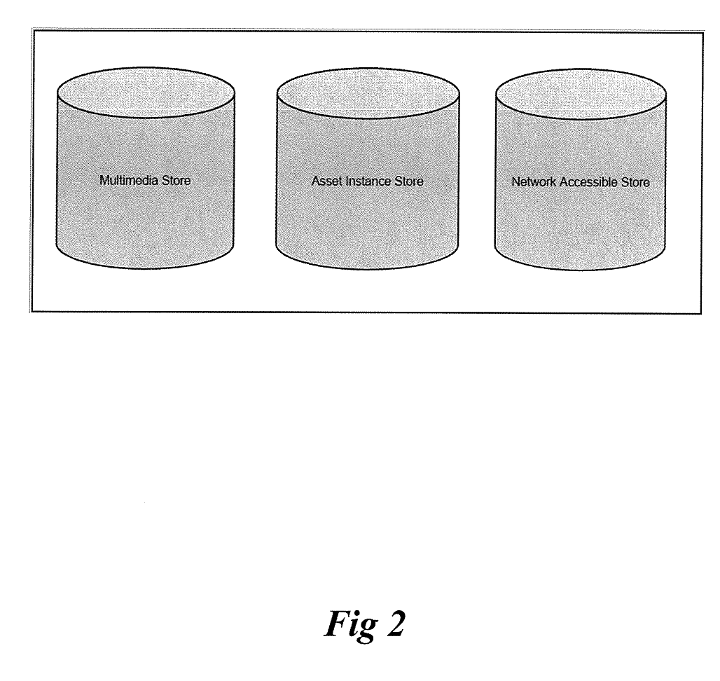

FIG. 2 shows a data storage model in one embodiment. The data storage model is optionally advantageous in that it records asset instances and their association through asset links. As referred to herein an “asset instance,” is the manifestation of a to-be recorded asset and its associated data to describe the asset. Further included with the recording of an asset instance are recordings of associations between asset instances known as asset links, which then form a basis for an asset map.

In one embodiment, the data storage model uses three distinct data stores. These data stores can be manual, digital or temporary and each record interrelated data on each asset instance. Three distinct data stores include but are not limited to an asset instance store, a multimedia store and a network accessible data store.

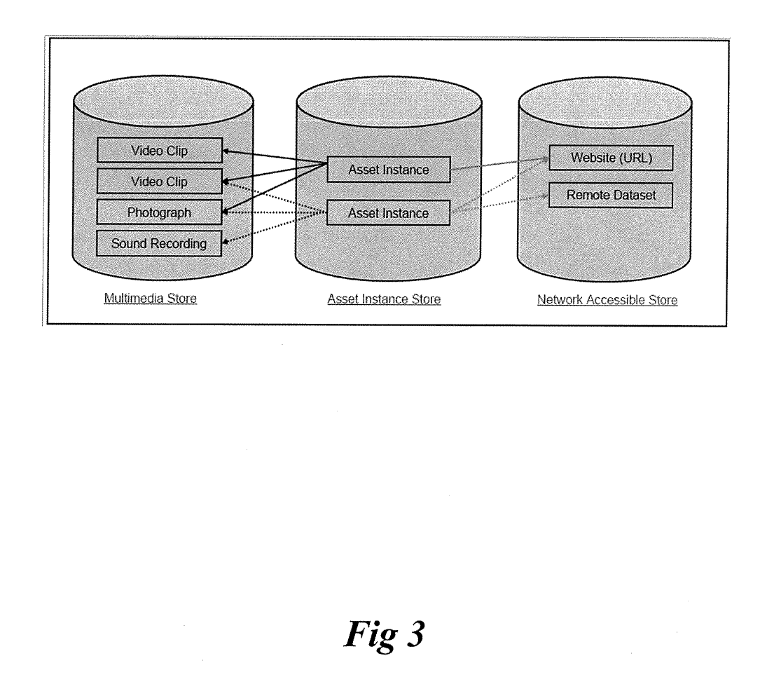

FIG. 3 shows a data storage model representing asset instance relationships. Each asset instance can be associated (related) to multiple objects within the multimedia store and or the network accessible store. Objects in the multimedia store and network accessible store can be associated (related) with multiple asset instances.

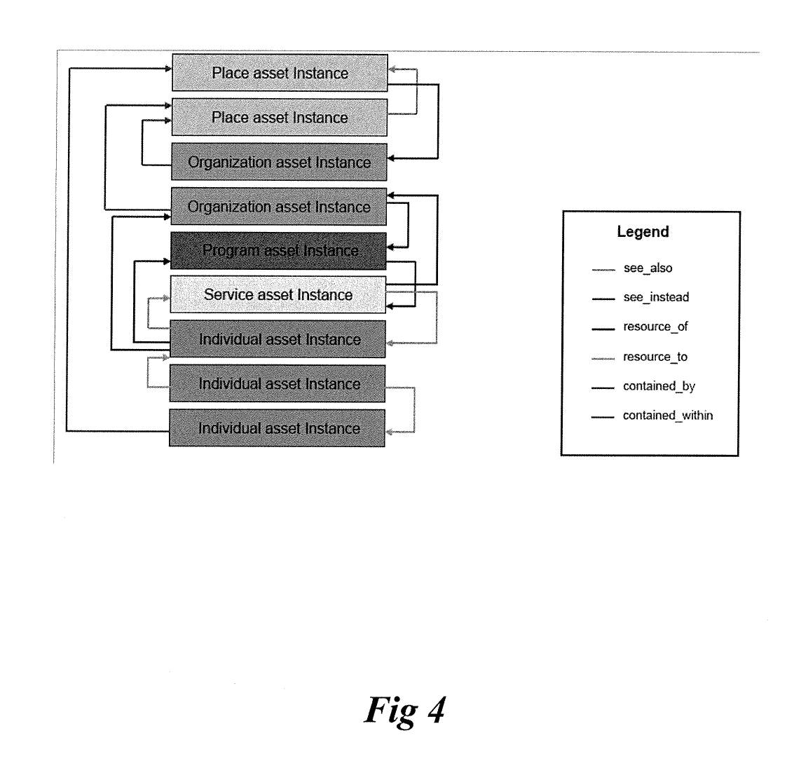

FIG. 4 shows an asset instance store. The asset instance store encodes and records both the asset instance and the asset links of each asset instance in one single data instance representing the overall asset or a record. Each asset instance can be associated, related to, linked with any other asset instance in the asset store through asset links. There can be an unlimited number of asset links between or within asset instances.

Asset instances are recorded using a variable length data structure, which accommodates a variable field count, an ability to repeat the same field, a variable subfield count within the fields, and the ability to repeat subfields within the same field. Further, each field within the asset instance can be linked with the same asset instance using, a one too many relationship, or to any other field within that asset instance. Assets instances are categorized using an asset instance classification method. Each of these asset instance classification represents a unique type of asset instance with characteristics which distinguishes one asset instance from another. An example asset instance classification includes a place, an organization, an individual, an event, a resource, and/or an institution.

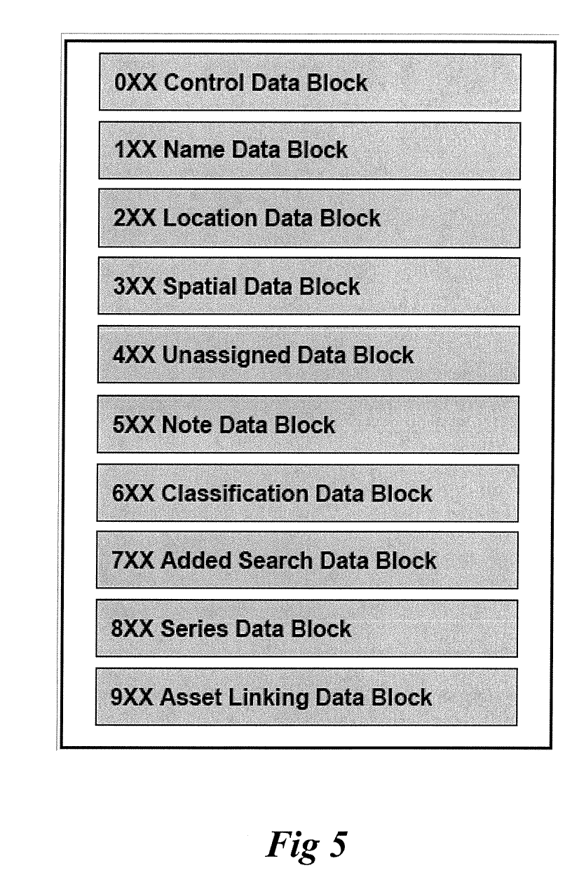

FIG. 5 shows an example asset instance main data structure. Each asset instance consists of a data element, which is logically grouped together in data blocks. Each of these data blocks contains an unlimited number of fields, and each of these fields can have an unlimited number of relationships to other fields. Further, the same field is repeatable within each of the data blocks. Each of the fields can have an unlimited and varying number of subfields which are repeatable within a field.

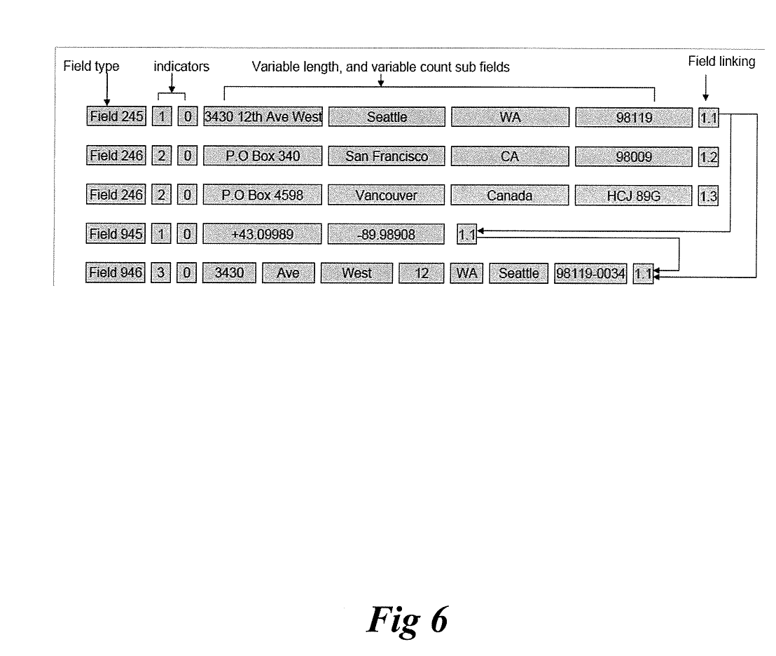

FIG. 6 shows an example of links of fields and subfields within a single asset instance.

In one embodiment, the system and method, includes a data store access model. The asset instance store has a browse facility associated with it. This browse capacity facilitates a quick search/browse/scan operation to take place on the recorded asset instances. A browse capacity across all three data stores could be used to only return those results which have a particular type of multimedia associated with it.

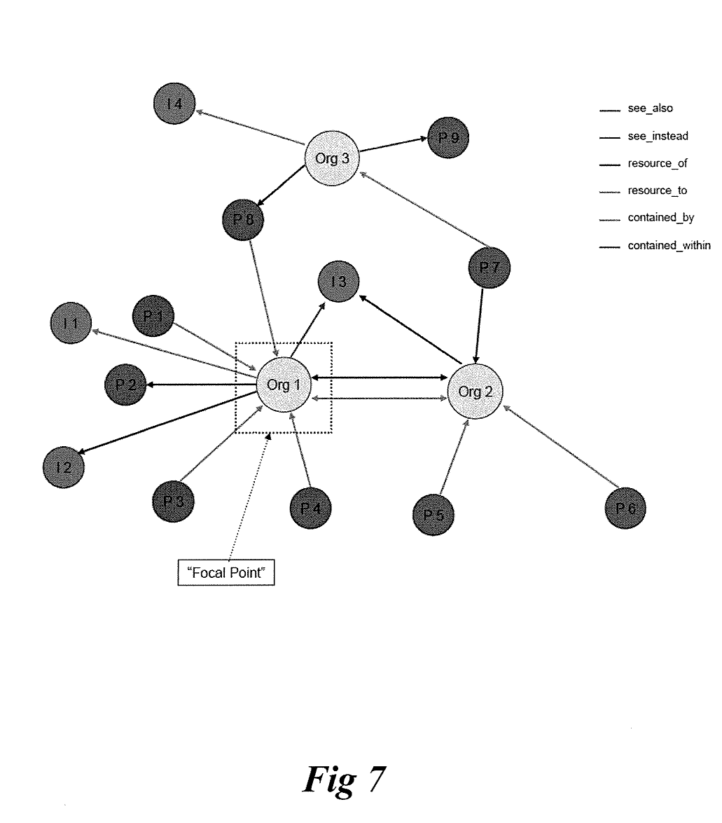

FIG. 7 shows an example of asset relationship exploration. Each asset relationship exploration has a focal point. It further contains first dimension asset links. First dimension asset relationships share a common asset instance, and in this case it is the focal point. Second through n dimension asset relationships require n−1 asset instances to travel through before reaching the focal point. The effect of the focal point on the asset link relationships in the second and higher dimension is particularly influential on the calculation of the perceived strength of the relationship from the vantage point of a user's focal point. For example, if the focal point is on the asset instance “ORG 1” then the strength of third dimension association of asset instance “I 4” to “I 2” is stronger than that of object “P 6” to asset instance “P 9” which occurs through the asset instance “ORG 2” and never interacts directly with the focal point. Thus, the focal point plays an integral role in the calculation of the predicted and possible asset associations.

In one embodiment, there are three processes which form the asset mapping system, these include: recording asset instances, recording asset links and/or exploring and generating asset maps including potential asset links.

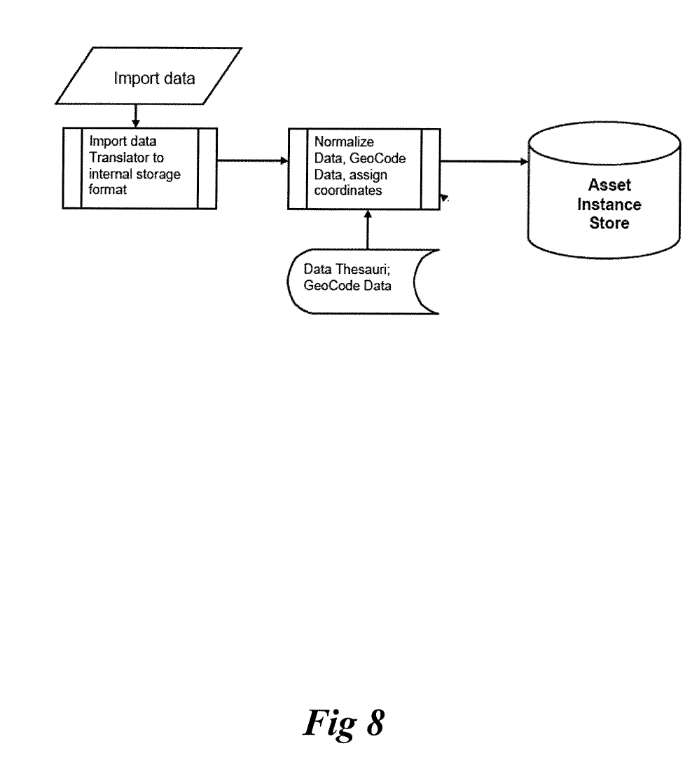

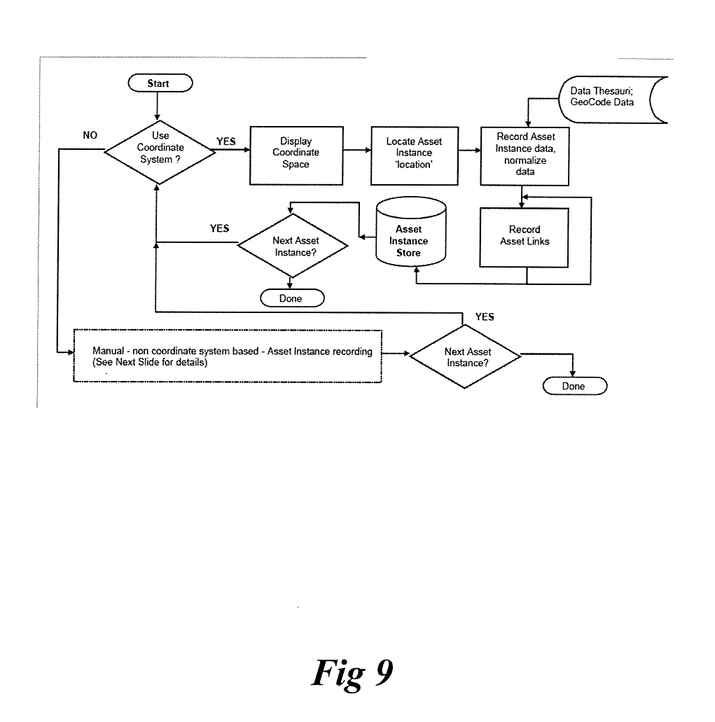

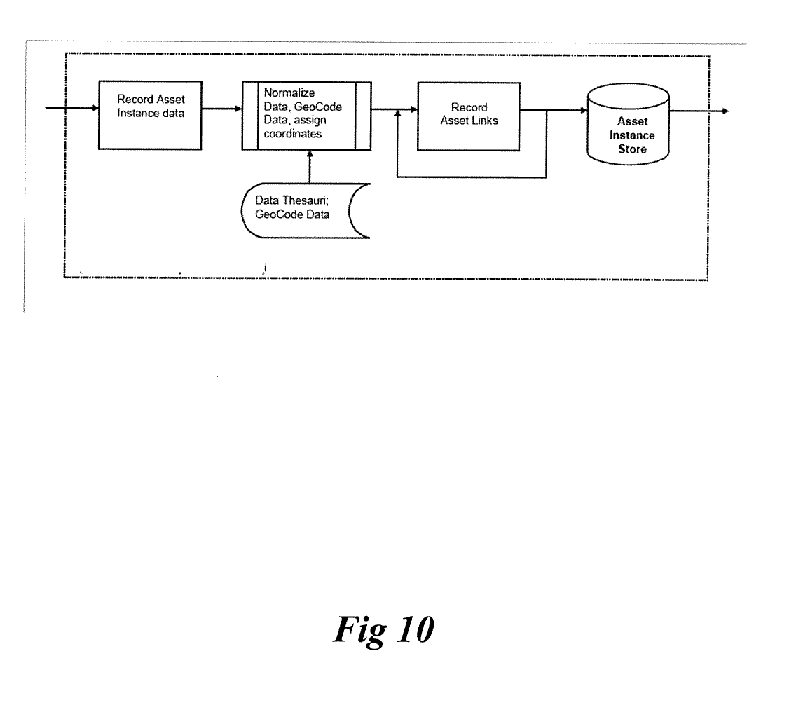

FIG. 8 shows automatic creation of asset instances using imported data. Incoming data, in for example CSV, XML, Excel format, is translated and converted to the internal asset instance data format for further processing and storage. Data is normalized using control tables to ensure integrity. Address information is then GeoCoded and/or assigned other coordinates for eventual mapping and display. FIG. 9 shows an example of interactive creation of asset instances. FIG. 10 shows an example of a manual, non coordinate system based asset instance recording.

Asset links can be recorded in many ways, including but not limited to: an imported set of asset instances, which have predefined relationships encoded between asset instances; additional imported asset instances already recorded in the system; manually coded using an asset instance data explorer; machine generated, based on a set of relationship criteria; and/or machine generated based on one plus n steps removed from a known relationship.

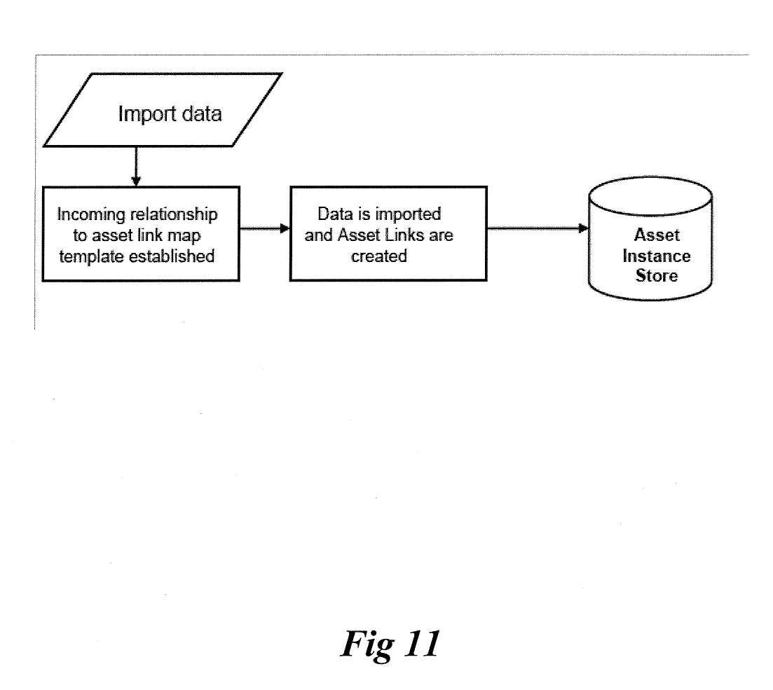

FIG. 11 shows an example of pre-defined asset link creation based on pre-coded relationships. The asset links are encoded during the import of the larger data set of asset instances, which includes data that may contain embedded relationships.

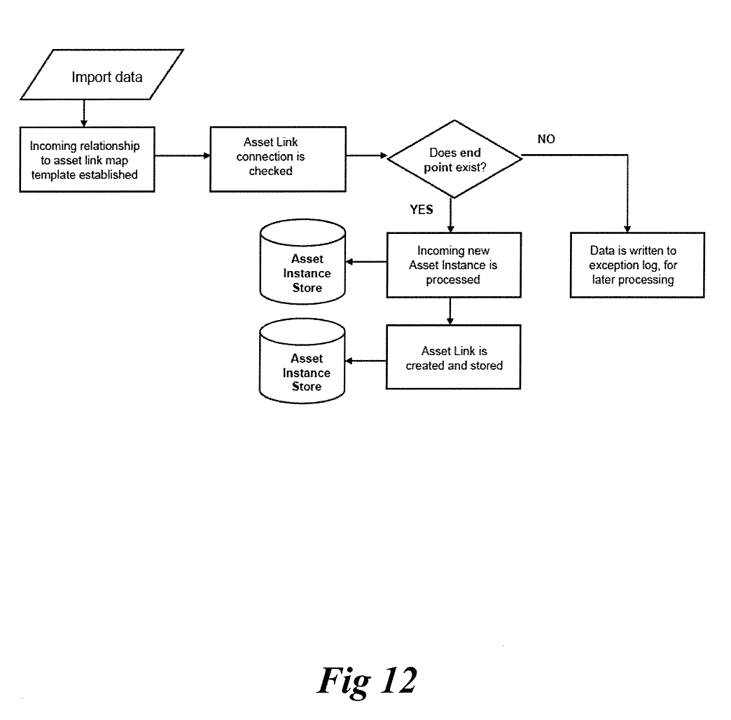

FIG. 12 shows an example of asset link creation based on imported data.

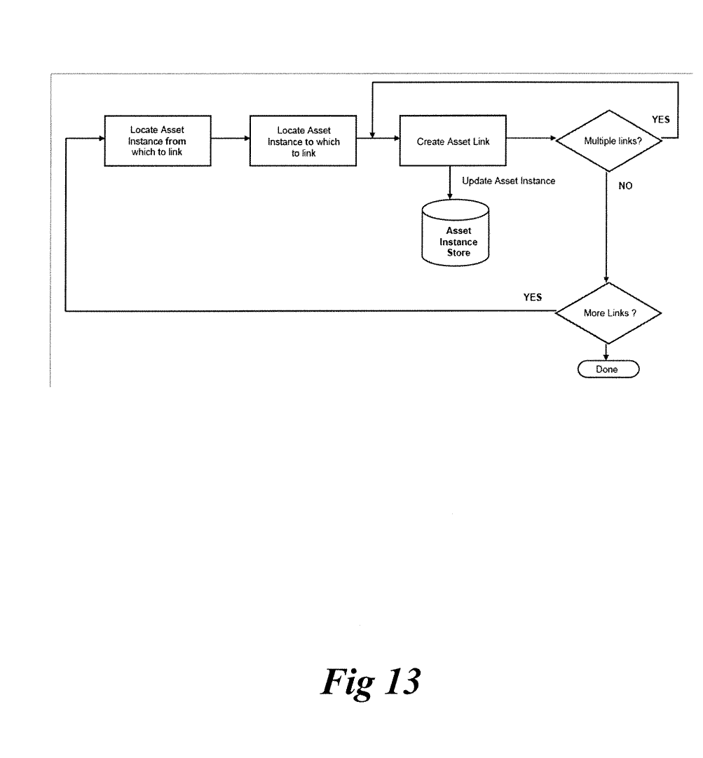

FIG. 13 shows an example of manual asset link creation.

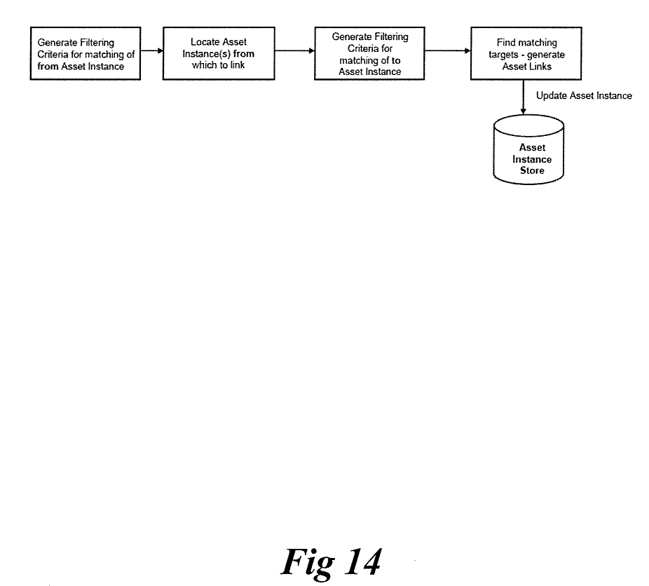

FIG. 14 shows an example of machine asset link creation.

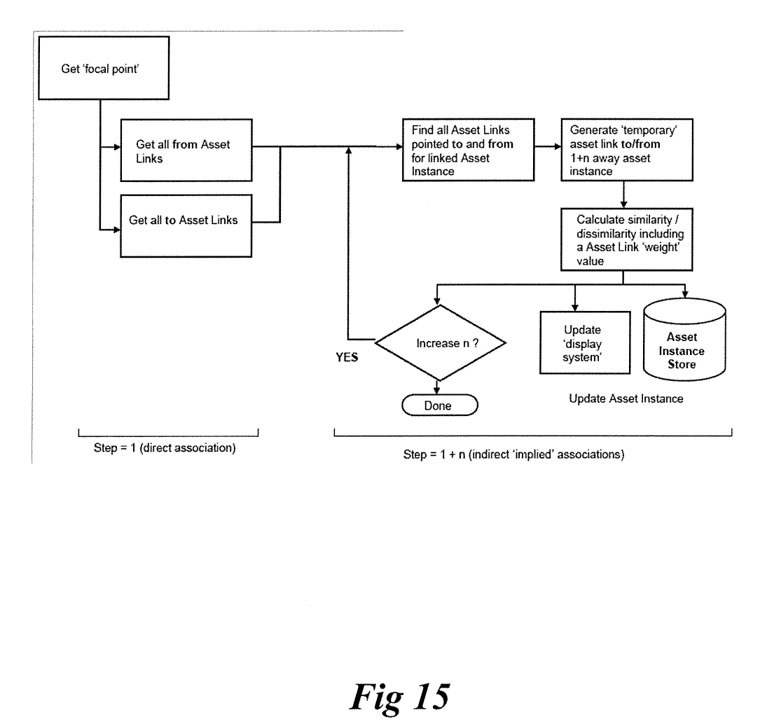

FIG. 15 shows an example of potential asset link discovery one plus n steps removed from a known relationship.

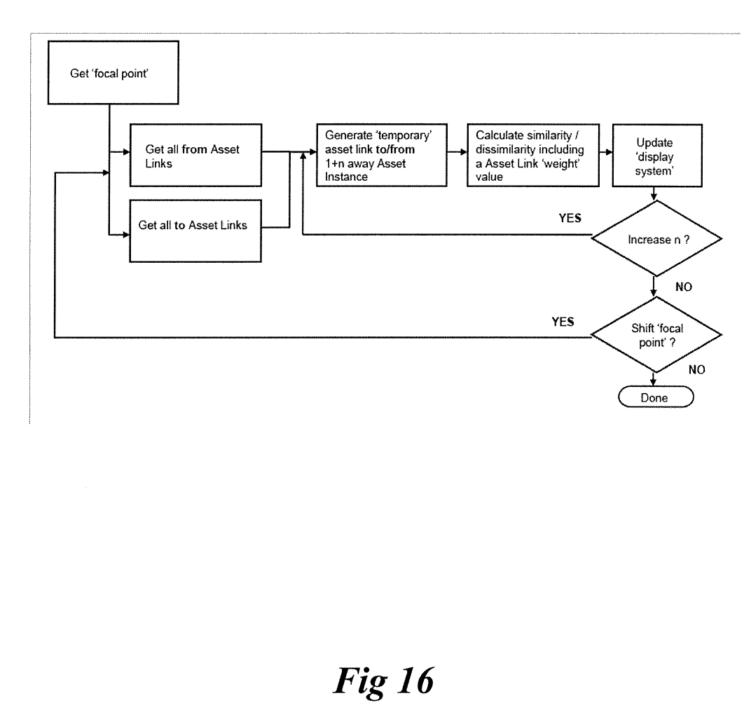

FIG. 16 shows an example of an asset relationship exploration process.

While the preferred embodiment of the invention has been illustrated and described, as noted above and in the attached accompanying materials, many changes can be made without departing from the spirit and scope of the invention. Accordingly, the scope of the invention is not limited by the disclosure of the preferred embodiment.

The embodiments of the invention in which an exclusive property or privilege is claimed are defined as follows:

1. A method for asset mapping comprising:
storing at least one asset instance on a computer readable medium;
processing the at least one asset instance, such that processed extracted data is stored within a series of fields in at least one data store;
mapping the at least one asset instance using asset linking; and
displaying the at least one asset instance on a user interface.
